(19) United States
(12) Patent Application Publication
(10) Pub. No.: US 2022/0005158 A1
(43) Pub. Date: Jan. 6, 2022

(54) MULTI-LAYERED MLA STRUCTURE FOR CORRECTING REFRACTIVE INDEX ABNORMALITY OF USER, DISPLAY PANEL, AND IMAGE PROCESSING METHOD

(71) Applicant: PIXELRO CO., LTD, Uiwang-si, Gyeonggi-do (KR)

(72) Inventors: Jong Woo LEE, Seongnam-si, Gyeonggi-do (KR); Hee Dong KIM, Namyangju-si, Gyeonggi-do (KR); Jae Won YUN, Suwon-si, Gyeonggi-do (KR); Seok Myong KANG, Hwaseong-si, Gyeonggi-do (KR)

(21) Appl. No.: 17/297,177

(22) PCT Filed: Feb. 18, 2019
(86) PCT No.: PCT/KR2019/001908

§ 371 Date: May 26, 2021

(30) Foreign Application Priority Data
Nov. 29, 2018 (KR) 10-2018-0151089

(51) Int. Cl. G06T 5/00; G02B 3/00; G02B 27/00; G06F 3/147; G06F 3/01

(52) U.S. Cl. CPC G06T 5/001; G02B 3/0062; G06F 3/013; G06F 3/147; G02B 27/0093

(57) ABSTRACT

Provided a multilayered MLA structure for correcting the refractive power abnormality of the user, and the multilayered MLA structure, as a multilayered MLA structure for correcting according to the refractive power abnormality of the user and the screen of the display panel for a user with refractive power problems in the eyes, including presbyopia, myopia, and hyperopia. It includes: a first MLA lens, which is spaced apart from the display panel by the first gap (gap . . . 1) by having the lower thickness of the first gap (gap_1) of the display panel, and which has the first lens's height (lens_sag_height_1); a first gap layer on the first MLA lens having the first thickness (gap_thickness_1); a second MLA lens, which is spaced apart from the first gap layer by the second gap (gap_2) by having the lower thickness of the second gap (gap_2), and which has the second lens's height (lens_sag_height_1); an. n-th gap layer On the n-th MLA. lens having the nth thickness (gap_thickness_n) (n is a natural number equal to or greater than 2); and an n-th MLA lens, which is spaced apart from the n-th gap layer by the n-th gap (gap_n) by having the lower thickness of the n-th gap (gap_n), and which has the n-th lens's height (lens_sag_heigh_n).

TECHNICAL FIELD

The present disclosure relates to a multilayered MLA structure for correcting the refractive power abnormality of a user, display panel, and image processing method, and more particularly, of an image processing method for displaying the generated image prime of an app display by processing a generated image through the multilayered MLA structure on the one hand and processing the entire image of an underlying app on the other, thereby generating a corrected image prime according to the refractive power abnormality degree of the user, the image processing method using the multilayered MLA structure to correct the display screen at a distance of 20 cm or more to match the eye's refractive power, and the processed images according to the optical effect generated from the structure, as a method for correcting the screen of a display device according to the refractive power abnormality degree of a user having refractive power problems in the eyes, such as presbyopia, myopia and hyperopia.

Moreover, it is an image processing method that uses a multilayered MLA to correct the display screen at a distance of 20 cm or more to match the refractive power of the eye and process the image according to the optical effect generated from this structure.

### BACKGROUND ART

As a display for presbyopia correction, the Korean Registered Patent Publication No. 10-0297691 (Invention Title: Display system adopting means for compensating for presbyopia, Registration Date: May 24, 2001) may be cited as a conventional patent document. The concerned patent document discloses “a display system including: a display forming an image; a camera outputting imaging information by imaging a crystalline lens of a viewer viewing the image; and a controller receiving the imaging information from the camera to calculate a yellow coloration degree of the crystalline lens and controlling the display so that the blue light-emitting amount of the display is increased depending on a correction value thereof.”

However, as the conventional patent document does not disclose a configuration for correcting the display screen according to the eye's refractive power at a distance of 20 cm or more, there is a problem that a convenient high-resolution system has not been provided to a user with presbyopia in real life.

### RELATED ART DOCUMENT

### Patent Document

Korean Registered Patent Publication No. 10-0297691 (Invention Title: Display system adopting means for compensating for presbyopia, Registration Date: May 24, 2001)

### DISCLOSURE OF INVENTION

### Technical Subject

The present disclosure has been made to resolve the abovementioned problem, and the objective of the present disclosure is to provide a multilayered MLA structure for correcting the refractive power abnormality of a user, display panel, and image processing method, capable of solving the issue of a display screen correcting and generating technique using a conventional MLA that has limitations in the disposition location of the MLA in the correction of the screen according to a user at a close range of several centimeters (i.e the disposition of a distance between the MLA and the display is: a point where practicality is decreased as the display screen becomes very large so that the area that the user can see at a glance is made very narrow when generating the effect so that the MLA is moved to a distance capable of generating the correction effect in case of satisfying a correction effect by placing the display and the MLA very close to each other; a point that this also decreases practicality a.s the distance between the display and the MLA should be maintained significantly in case of making the screen to an appropriate size level, and other points).

### Technical Solution

A multilayered MLA structure for correcting the refractive power abnormality of the user according to an embodiment of the present disclosure for achieving the foregoing object, as a multilayered MLA structure for correcting according to the refractive power abnormality of the user and the screen of the display panel for a user with refractive power problems in the eyes, including presbyopia, myopia, and hyperopia, includes: a first MLA lens, which is spaced apart from the display panel by the first gap (gap_1) by having the lower thickness of the first gap (gap_1) of the display panel, and which has the first lens's height (lens_sag_height_1); a first gap layer on the first MLA lens having the first thickness (gap thickness 1); a second MLA lens. which is spaced apart from the first gap layer by the second gap (gap_2) by having the lower thickness of the second gap (gap 2), and which has the second lens's height (lens sag height 2); an n-th gap layer on the n-th MLA lens having the nth thickness (gap thickness n) (n is a natural number equal to or greater than 2); and an n-th MLA lens, which is spaced apart from the n-th gap layer by the n-th gap (gap_n) by having the lower thickness of the n-th gap (gap_n), and which has the n-th lens's height (lens_sag_height_n).

According to another embodiment of the present disclosure, a display panel, including a multilayered MLA structure for correcting according to the refractive power abnormality degree of the user and the screen of the display panel for a user with refractive power problems in the eyes, including presbyopia, myopia, and hyperopia, includes: a display panel; and a multilayered MLA structure for correcting the refractive power abnormality of the user, which includes: a first MLA lens, which is spaced apart from the display panel by the first gap (gap_1) by having the lower thickness of the first gap (gap_1) of the display panel, and which has the first lens's height (lens_sag_height_1); a first gap layer on the first MLA lens having the first thickness (gap_thickness_1) a second MLA lens, which is spaced apart from the first gap layer by the second gap (gap_2) by having the lower thickness of the second gap (gap 2), and which has the second lens's height (lens_sag_height_2); an n-th gap layer on the n-th MLA lens having the n-th thickness (gap_thickness_n) (n is a natural number equal to or greater than 2); and an n-th MLA lens, which is spaced apart from the n-th gap layer by the n-th gap (gap_n) by having the lower thickness of the n-th gap (gap_n), and which has the n-th lens's height (lens_sag_height_n).

Here, the display panel controls the overlapping of images caused by the multilayered MLA structure based on the result values of the eye position and distance-detecting part by including a user eye position and distance-detecting part that detects the position and distance of the user's eyes.

Furthermore, a second image (image_2) by the first MLA lens for the first image (image_1), a third image (image_3) by the second MLA lens for the second image (image_2), and an n+1-th image (image_n+1) by the n-th MLA lens for the n-th image (image_n) are generated when there is a first image (image_1) to be displayed on the display panel. Moreover, in the formulas

$${S}_{1}^{′} = \frac{{f}_{1} {S}_{1}}{{S}_{1} - {f}_{1}} and {M}_{1 =} \frac{{S}^{′}}{{S}_{1}} ,$$

the distance between the first image (image_1) and the first MLA lens is expressed as S1, the distance between the second image (image_2) and the first MLA lens is expressed as S1′, the focal distance is expressed as f1, and the magnification of the second image with respect to the first image is expressed as M1. In the formulas

$${S}_{n}^{′} = \frac{{f}_{n} {S}_{n}}{{S}_{n} - {f}_{n}} and {M}_{n =} \frac{{S}_{n}^{′}}{{S}_{n}} ,$$

the distance between the n-th image (image_n) and the n-th MLA lens is expressed as Sn, the distance between the n+1-th image (image_n+1) and the n-th MLA lens is expressed as Sₙ′, the focal distance is expressed as fₙ, and the magnification of the n+1-th image with respect to the n-th image is expressed as Mₙ.

Meanwhile, according to another embodiment of the present disclosure, an image processing method for correcting the refractive power abnormality of a user in a display panel involves: capturing the entire image of an underlying app; processing the entire image of the underlying app and generating an image prime corrected according to the refractive power abnormality degree of the user; and displaying the image prime as the entire image of the front app.

Furthermore, the image processing method preferably involves: detecting whether there is a change in the underlying app; and transparently processing the entire image of the front app when there is a change in the underlying app.

Meanwhile, the step of detecting whether there is a change in the underlying app may involve: transparently processing a set of pixels at a specific location among the entire image of the front app to have a pixel value of the corresponding image of the underlying app in the set of pixels at the particular location; and detecting a change in the underlying app by comparing a set of pixels at the transparent location between the previous image of the front app and the current image of the front app.

In addition, the step of detecting whether there is a change in the underlying app may further involve injecting a unique magic code over time for the pixel at the transparent location in at least the image prime to prevent the image prime from being unable to detect a change in the underlying app caused by the occurrence of a dropped image in which an image is missing because of the synchronization of the fence signal.

Furthermore, the step of detecting a change in the underlying app by comparing a set of pixels at the transparent location between the previous image of the front app and the current image of the front app may involve the confirmation of the dropped image by checking the magic code of the pixel at the transparent location.

Here, the step of processing the entire image of the underlying app and generating an image prime corrected according to the refractive power abnormality degree of the user involves: detecting the angle of the user's eye based on the distance between the user's eye and the display panel and a direction between the unit lens and the user, as a step of detecting the angle of the user's eye and the angle of incidence of an image entering the eye through a unit lens of the multilayered MLA structure; locating the central position of the moved image based on the center of the lens in a state parallel to the user's eye and the angle of the eye looking at the moved image, as a step of locating the central position of an image moved by the unit lens of the multilayered MLA structure; and extracting the image according to the size of a proportion at which the image is magnified based on the central position of the moved image.

### Advantageous Effects

A vision correction method of processing an image generated through a multilayered MLA structure according to the present disclosure makes it possible to feel the screen recognition and correction effect at the usual use distance, even without maintaining a large distance between the display and the MLA by placing arrays with different lens properties in several layers in the conventional single layer-type lens array arrangement.

That is, the multilayered lens may generate an effect of correcting the screen through image movement while widening an area that the user can view through the MLA by preventing the size of the image of the moved lens from becoming larger than that of the screen source of the display even as the multilayered lens can move at the same level as a single-layered lens.

Moreover, the generation of a moving distance effect through small magnification may produce an effect of clearly showing the image even from a long distance by increasing the resolution of the moved image.

### BRIEF DESCRIPTION OF DRAWINGS

FIG. 1 illustrates the interpretation in the case of arranging two lenses.

FIG. 2 shows how an image can be processed so that image 1 and image 2 are recognized as one image by arranging the same image on an overlapping region of image 1 and image 2, wherein a retinal image becomes a combination of image 1 and image 2 formed on individual lens arrays.

FIG. 3 shows an example of a side sectional view of a multilayered MLA structure according to the present disclosure.

FIG. 4 shows an image processing method for images formed through the MLA part (part “a” of FIG. 4) of a multilayered structure formed in the same structure as in FIG. 3.

FIG. 5 shows a basic image processing flowchart.

FIG. 6 shows a transparent pixel set of a front app user interface (UI), and it illustrates the sensing of a change in the underlying app UI through this.

FIG. 7 illustrates the method for enabling the underlying app UI to be captured (i.e., acquiring images of the underlying app UI by transparently processing the entire region of the front app UI).

FIG. 8 is a block diagram showing the detailed configurational diagram of the entire logic for processing the captured images.

FIG. 9 shows the process of obtaining the image area angle looking through the MLA from the eyeball, virtual image area coordinates looking through the MLA from the eyeball, and display area coordinates mapped to the virtual image by classifying the case as one where the MLA is inside and outside the eyeball region.

### BEST MODE FOR CARRYING OUT THE INVENTION

Hereinafter, preferred embodiments according to the present disclosure will be described in detail with reference to the attached drawings. Prior to this, terms or words used in the present specification and the claim scope should not be construed to be limited to ordinary or dictionary meanings, and the inventor should interpret the invention as meanings and concepts consistent with the technical ideas of the present disclosure based on the principle that the concepts of the terms can be properly defined to explain the inventor's own invention in the best manner.

Therefore, as the embodiments specified in the present specification and configurations shown in the drawings are just the most desirable examples of the present disclosure and do not represent all of the technical ideas of the present disclosure, it should be understood that there may be various equivalents and modified examples capable of replacing them at the time of the present application.

Furthermore, the present disclosure is intended to make it possible to feel the screen recognition and correction effect at the usual use distance even without maintaining a large distance between the display and the MLA by placing arrays with different lens properties in several layers in the conventional single layer—type lens array arrangement.

Moreover, a multilayered MLA structure according to the present disclosure, as a multilayered MLA structure for correcting according to the refractive power abnormality of the user and the screen of the display panel for a user with refractive power problems in the eyes, including presbyopia, myopia, and hyperopia, includes: a first MLA lens, which is spaced apart from the display panel by the first gap (gap_1) by having the lower thickness of the first gap (gap_1) of the display panel, and which has the first lens's height (lens_sag_height_1); a first gap layer on the first MLA lens having the first thickness (gap_thickness_1); a second MLA lens, which is spaced apart from the first gap layer by the second gap (gap_2) by having the lower thickness of the second gap (gap_2), and which has the second lens's height (lens_sag_height_2); an n-th gap layer on the n-th MLA lens having the n-th thickness (gap_thickness_n) (n is a natural number equal to or greater than 2); and an n-th MLA lens, which is spaced apart from the n-th gap layer by the nth gap (gap_n) by having the lower thickness of the n-th gap (gap_n), and which has the n-th lens's height (lens_sag_height_n).

In addition, as the multilayered MLA structure like this is made separately from the display panel, the multilayered MLA structure can be attached to the display panel or formed to be integrated with a display panel structure on the upper layer of the display panel.

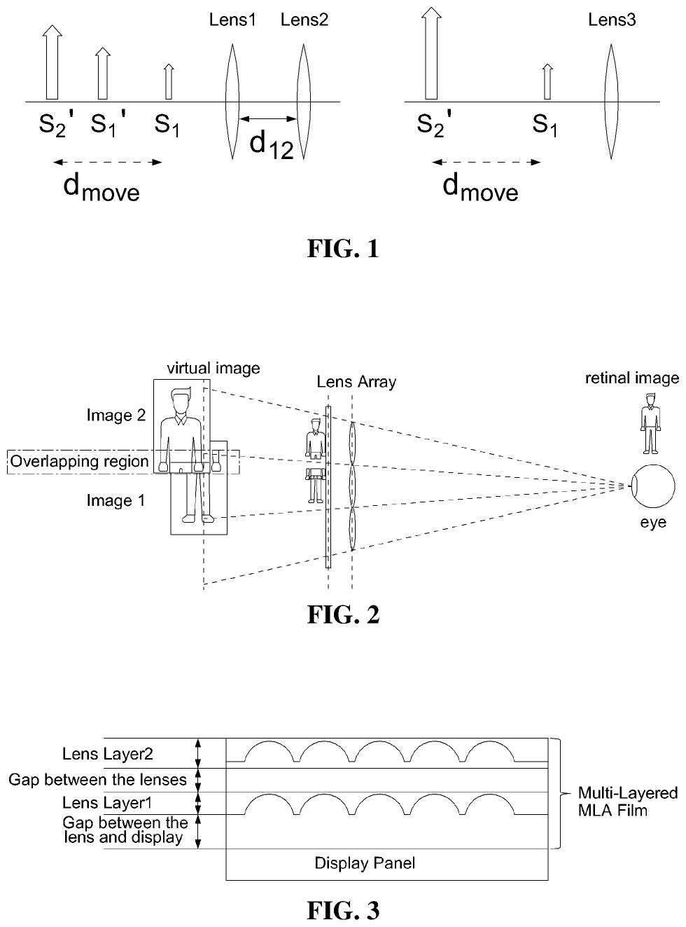

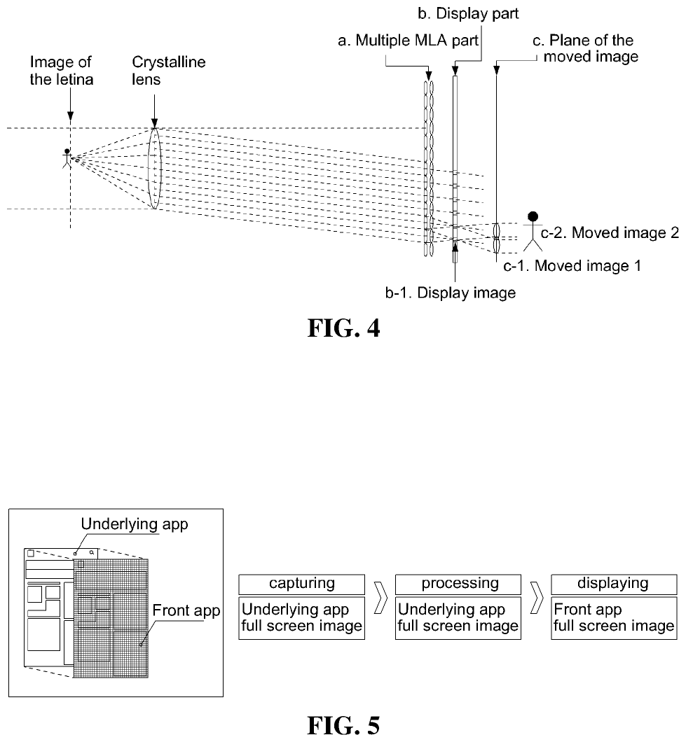

FIG. 1 illustrates the interpretation process of arranging two lenses. FIG. 2 shows that the retinal image can be processed so that image 1 and image 2 are recognized as one image by arranging the same image on an overlapping region of image 1 and image 2, wherein a retinal image formed on the retina becomes a combination of image 1 and image 2 formed on individual lens arrays. FIG. 3 shows an example of a side sectional view of a multilayered MLA structure according to the present disclosure. FIG. 4 shows an image processing method for images formed through an MLA part (part “a” of FIG. 4) of a multilayered structure formed in the same structure as in FIG. 3.

Meanwhile, the interpretation process in the case of arranging two lenses using FIG. 1 is explained. Furthermore, the position and magnification of an image may be calculated through the lens formula in the case of disposing several lenses, and the interpretation process of arranging two lenses as in FIG. 1 is as follows.

As shown in FIG. 1, the image S1′ made by the first black lens (lens 1) for an object named S1 and the magnification M1 of the image are calculated in formula 1.

$${s}_{1}^{′} = \frac{{f}_{1} {s}_{1}}{{s}_{1} - {f}_{1}} {M}_{1} = \frac{{s}_{1}^{′}}{{s}_{1}} \qquad Formula 1$$

S1′ becomes the object S2 of the second green lens (lens2), and the image S2′ made by the object and the magnification M2 are calculated in formula 2.

$${s}_{2} = {s}_{1}^{′} + {d}_{1 {2}^{=}} \frac{{f}_{{1}^{S} 1}}{{s}_{1} - {f}_{1}} + {d}_{12} \\ {s}_{2}^{′} = \frac{{f}_{2} {s}_{2}}{{s}_{2} - {f}_{2}} {M}_{2} = \frac{{s}_{2}^{′}}{{s}_{2}} \qquad Formula 2$$

The magnification of a final image is produced by the multiplication of M1 and M2. Here, when comparing magnifications for the position of the object S1 and the position of the image S2′, the magnification of an image actually formed by two lenses becomes smaller than S2′/S1 (i.e., a magnification obtained when forming an image as S2′ by allowing a single lens [lens3] to equally move the object S1 as much as dₘₒᵥₑ, as shown in formula 3).

$${M}_{12} = {M}_{1} {M}_{2} = \frac{{S}_{1}^{′}}{{S}_{1}} \frac{{S}_{2}^{′}}{{S}_{2}} = \frac{{S}_{1}^{′}}{{S}_{1}} \frac{{S}_{2}^{′}}{{S}_{1}^{′} + {d}_{12}} < \frac{{S}_{2}^{′}}{{S}_{1}} \qquad Formula 3$$

The movement to an image distance that has a correction effect using this principle may be generated even with a small magnification. Moreover, the generation of a moving distance effect through the small magnification may produce effects of clearly showing the image and widening an image's visible area by increasing the resolution of the moved image, regardless of whether the image is moved to a long distance.

If the previously described contents are expanded, wherein the second image (image_2) by the first MLA lens for the first image (image_1), the third image (image_3) by the second MLA lens for the second image (image_2), and the n+1-th image (image_n+1) by the n-th MLA lens for the n-th image (image_n) are generated when there is a first image (image_1) to be displayed on the display panel, the formulas

$${S}_{1}^{′} = \frac{{f}_{1} {S}_{1}}{{S}_{1} - {f}_{1}} and {M}_{1 =} \frac{{S}^{′}}{{S}_{1}}$$

will mean that the distance between the first image (image_1) and the first MLA lens is expressed as S1, the distance between the second image (image_2) and the first MLA lens is expressed as S1′, the focal distance of the first MLA lens is expressed as f1, and the magnification of the second image with respect to the first image is expressed as M1. Moreover, the formulas

$${S}_{n}^{′} = \frac{{f}_{n} {S}_{n}}{{S}_{n} - {f}_{n}} and {M}_{n =} \frac{{S}_{n}^{′}}{{S}_{n}}$$

will mean that the distance between the n-th image (image_n) and the n-th MLA lens is expressed as Sₙ, the distance between the n+1-th image (image_n+1) and the n-th MLA lens is expressed as S_{n′}, the focal distance of the n-th MLA lens is expressed as fₙ, and the magnification of the n+1-th image to the n-th image is expressed as Mₙ, and the n-th MLA lens improves the resolution compared to single lenses with magnifications of M₁, M₂, . . . Mₙ.

The present disclosure is made by the principle described through FIG. 1, and images generated by individual lenses in a multilayered MLA are more expanded than the display so that the images are overlapped with each other at a position where the images are formed. A desired entire image may be made by calculating the portions that overlapped on the respective images generated by the individual lenses and disposing the same display image.

As shown in FIG. 2, a retinal image formed on the retina becomes a combination of image 1 and image 2 that are formed on individual lens arrays. In this case, the image can be processed so that image 1 and image 2 are recognized as one image by disposing the same image in an overlapping region of image 1 and image 2.

FIG. 3 shows an example of a side sectional view of a multilayered MLA structure according to the present disclosure. As shown in FIG. 3, the MLA of a multilayered structure (multilayered MLA) is formed by a method of disposing an MLA layer having a predetermined gap on the display and additionally disposing the MLA layer having a predetermined gap on the MLA layer. The gap and lens properties of individual MLAs are calculated by adjusting them to match a moving distance of the image. Here, it is possible to set the gap between the lens and the display, the height of the lens layer 1, the gap between lens 1 and lens 2 (properties of the material and the like of the gap), the height of the lens layer 2, etc. as necessary.

FIG. 4 shows the image processing method for images formed through the MLA part (part “a” of FIG. 4) of a multilayered structure formed in the same structure as FIG. 3. As shown in part “c” of FIG. 4, images are formed as some areas of the display (part “b” of FIG. 4) of the unit lens region move to a specific distance depending on the properties of the MLA part of the multilayer structure (part “c” of FIG. 4).

An image on the plane of the moved image is mixed and formed as a single combined image on the image of the retina by passing through a crystalline lens. The overlapping degree of the image varies depending on the position and direction of the user's eye, the overlapping degree of the image calculated according to a distance value between the crystalline lens, and the MLA part of the multilayered structure to find the size and image values of an overlapped part of the image (part “c-1” and “c-2” of FIG. 4). The overlapped area-processed image values are then extracted as image values of the display of part “b” of FIG. 4 (part “b-1” of FIG. 4). A processed image can be formed by finally moving the generated image of the display part to a certain distance from the user's eye when an image of the display part is generated by repeatedly performing these processes with respect to individual lens areas of the entire MLA.

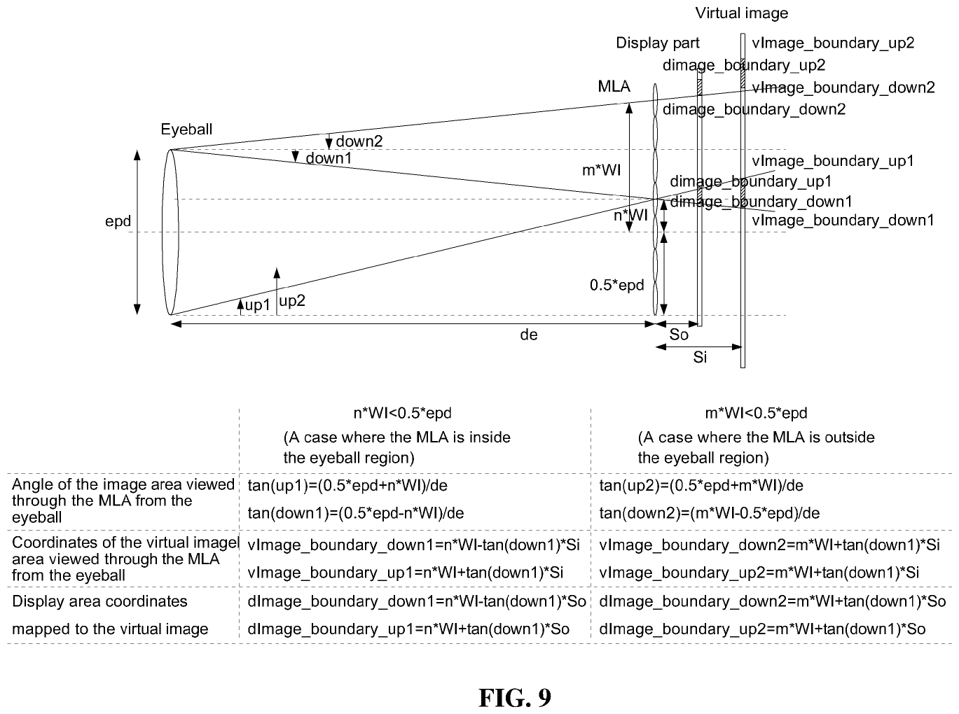

Here, to process the area of the image moved by the individual lens, a central position of the moved image is found, and the image is extracted according to the size of the magnification in which the image is enlarged based on the central position. To find the central position of the image moved by the individual lens, the position can be calculated according to the angle of the eye looking at the moved image, as shown in FIG. 9. The angle of the eye is the angle of incidence of an image that enters the eye through the individual lens. It is derived according to the distance between the eye and the display and the direction between the lens and the user.

An image area incident to the eye is extracted based on the moved central position by calculating a central position at which the center of the lens is moved in a state parallel to the eye according to the derived angle of the eye.

The extracted area is adjusted to fit the size of the display area according to the magnification of the moved image and converted into a display image value. When the image value is extracted for the entire lens, the display image value of the image moved to a certain distance is obtained.

More specifically, it is divided into a case where the MLA is inside the eyeball region and the case where the MLA is outside the eyeball region. Moreover, the angle of an image area viewed through the MLA from the eyeball, the coordinates of a virtual image area viewed through the MLA from the eyeball, and the coordinates of a display area mapped to the virtual image may be obtained as shown in FIG. 9.

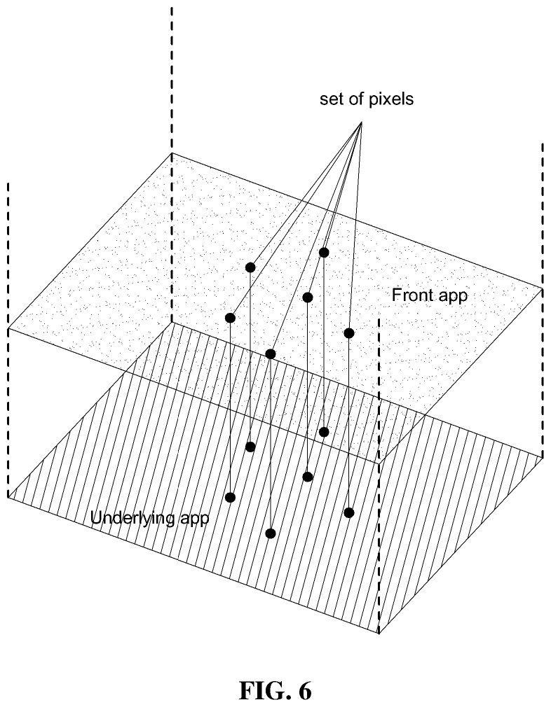

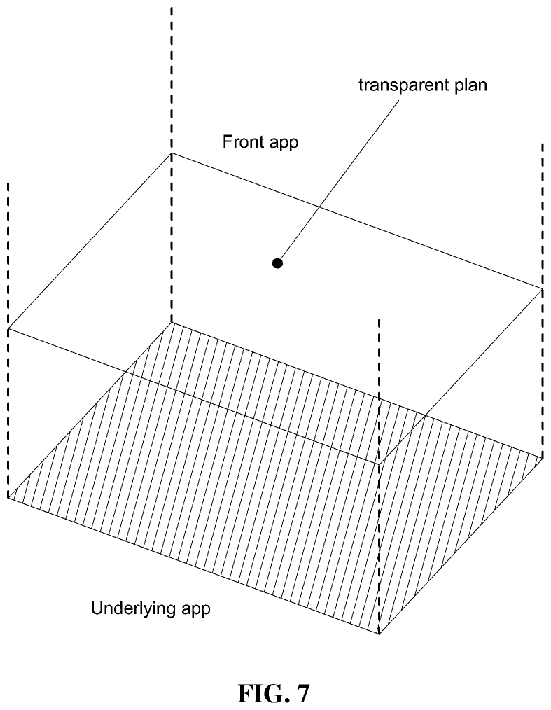

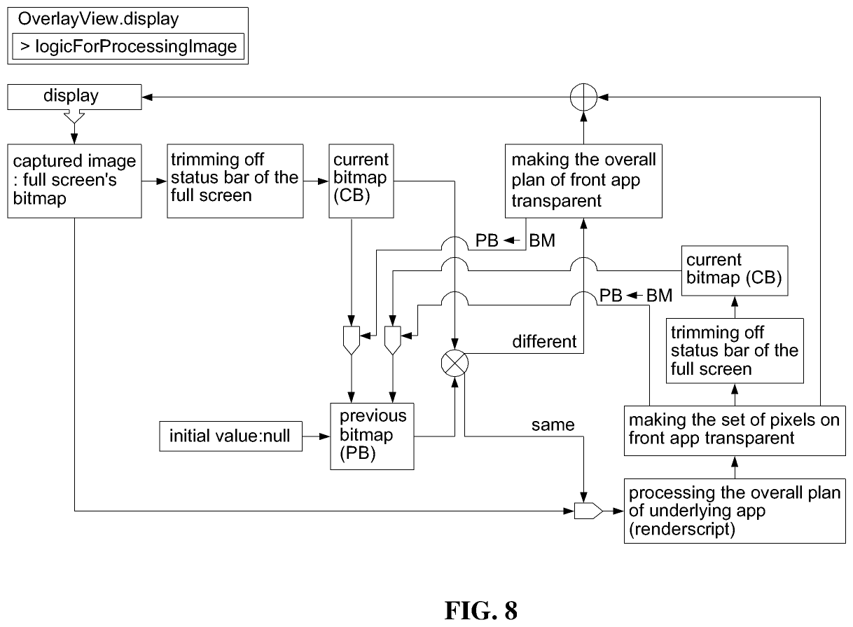

FIG. 5 shows a basic image processing flowchart, while FIG. 6 shows a transparent pixel set of a front app UI and explains the sensing of a change in the underlying app UI through this. On the other hand, FIG. 7 explains the method for enabling the underlying app UI to be captured (i.e., acquiring images of the underlying app UI) by transparently processing the entire region of the front app UI. FIG. 8 is a block diagram showing the detailed configurational diagram of the entire logic for processing the captured images.

Hereinafter, the techniques applicable to an application having a service that outputs an image after processing a specific image using an image of the screen currently displayed by a device will be described using FIGS. 5 to 8.

For example, to allow users with presbyopia to better see the image currently outputted on a smartphone screen, the techniques may be applied to an application that has a service function of outputting the image to the screen after processing the image.

Presented is a method for extracting the source image from a structural system that cannot obtain a source image through an independent channel when applied to a service application that has the function of outputting an image prime generated through a specific image processing from the image to the screen using the image currently outputted on the screen.

The underlying app UI is the source image, and the front app UI outputs an image prime obtained through image processing from the underlying app image.

However, the problem is that there is one channel for capturing an image that is currently outputted on the screen, and two images of the source image and the image prime independently coexist in terms of time in that channel. Here, the system (android framework, iOS framework, or the like) does not provide a method for acquiring only the source image from two images that independently coexist in terms of time. Thus, an algorithm acquiring the corresponding source image is required.

In a system that does not provide a function for capturing a source image (Underlying App UI) from an independent channel, the method for acquiring the source image is as follows.

The Underlying App UI is an app UI that operates under the Front App UI and is the source image of the image prime, which is outputted from the Front App UI. The Front App UI is an App UI that outputs an image prime of which an image is processed from the source image. The previous image of the front app (Previous Image of Front App UI) is a captured n-1-th Front App UI image. The current image of the front app (Current Image of Front App UI) is a captured n-th Front App UI image. The source image change detection logic (logic for detecting the changed source image) detects the change of the source image. In a magic code for detecting a dropped image prime, a phenomenon where the image prime is not outputted occurs as the image prime is dropped (dropped image prime) because of the synchronization of the fense signal when outputting the image prime to the screen. Therefore, whether the image prime is dropped is checked using the magic code by injecting the magic code into the image prime, thereby capturing a screen image.

FIG. 5 shows a basic image processing flowchart. As shown in FIG. 5, a full-screen image (source image) of the underlying app UI is captured, and an image (image prime) is outputted on the screen as a result of performing the image processing process on the captured image.

Next, the front app UI is outputted in an overlay method, and events for user interaction (screen touch) are delivered to the underlying app. The user touches the front app UI, but the user interaction events are delivered to the underlying app, and the underlying app processes the corresponding events (overlay application of the front app UI).

Furthermore, a pixel set at a specific location of the front app UI is transparently processed to know the change of the underlying app UI. The corresponding pixel set has an image pixel value of the underlying app UI and not an image pixel value of the front app UI. Therefore, when comparing a pixel set between the previous image of the captured front app UI and the current image of the front app UI, it can be seen that the underlying app UI image has changed. FIG. 6 shows a transparent pixel set of the front app UI (sensing of a change in the underlying app UI).

Afterward, when it is known that the image of the underlying app UI is changed, the underlying app UI can be captured if the entire front app UI is transparently processed, as shown in FIG. 7 (method for acquiring the image of the underlying app UI).

FIG. 8 is a block diagram showing the detailed configuration of the entire logic for processing the captured images.

After image-processing the source image, the image prime for output may be dropped because of the synchronization of the fence signal, which may cause an error in the logic for detecting a changed source image of the underlying app UI. Therefore, to detect the drop image prime, a unique magic code is injected over time into the pixel value of a specific location in the output image prime, and the pixel value is checked from the captured image to check whether it is dropped (application of magic code).

As described above, the present disclosure has been described by the limited embodiments and drawings, but the present disclosure is not limited thereto, and it goes without saying that various modifications and variations of the present disclosure can be made by those of ordinary skill in the art of which the present disclosure pertains within equivalent ranges of the technical ideas of the present disclosure and the scope of claims described below.

1. A multilayered MLA structure for correcting the refractive power abnormality of the user, as a multilayered MLA structure for correcting according to the refractive power abnormality of the user and the screen of the display panel for a user with refractive power problems in the eyes, including presbyopia, myopia, and hyperopia, the multilayered MLA structure comprising:
a first MLA lens, which is spaced apart from the display panel by the first gap (gap_1) by having the lower thickness of the first gap (gap_1) of the display panel, and which has the first lens's height (lens_sag_height_1);
a first gap layer on the first MLA lens having the first thickness (gap_thickness_1);
a second MLA lens, which is spaced apart from the first gap layer—by the second gap (gap_2) by having the lower thickness of the second gap (gap_2), and which has the second lens's height (lens_sag_height_2);
an n-th gap layer on the n-th MLA lens having the nth thickness (gap_thickness_n) (n is a natural number equal to or greater than 2); and
an nth MLA lens, which is spaced apart from the n-th gap layer by the n-th gap (gap_n) by having the lower thickness of the n-th gap (gap_n), and which has the n-th lens's height (lens_sag_height_n).

2. A display panel for correcting the refractive power abnormality of the user, as a display panel including a multilayered MLA structure for correcting according to the refractive power abnormality degree of the user and the screen of the display panel for a user with refractive power problems in the eyes, including presbyopia, myopia, and hyperopia, the display panel comprising:
a display panel;
a first MLA lens, which is spaced apart from the display panel by the first gap (gap_1) by having the lower thickness of the first gap (gap_1) of the display panel, and which has the first lens's height (lens_sag_height_1);
a first gap layer on the first MLA lens having the first thickness (gap_thickness_1);
a second MLA lens, which is spaced apart from the first gap layer by the second gap (gap_2) by having the lower thickness of the second gap (gap_2), and which has the second lens's height (lens_sag_height_2);
an n-th gap layer on the n-th MLA lens having the n-th thickness (gap_thickness_n) (n is a natural number equal to or greater than 2); and
an nth MLA lens, which is spaced apart from the n-th gap layer by the n-th gap (gap_n) by having the lower thickness of the n-th gap (gap_n), and which has the n-th lens's height (lens_sag_heigh_n).

3. The display panel for correcting the refractive power abnormality of the user of claim 2 includes a display panel that controls the overlapping of images caused by the multilayered MLA structure based on the result values of the eye position and distance-detecting part by including a user eye position and distance-detecting part that detects the position and distance of the user's eyes.

4. The display panel for correcting the refractive power abnormality of the user of claim 3, wherein the second image (image_2) by the first MLA lens for the first image (image_1), the third image (image_3) by the second MLA lens for the second image (image_2), and the n+1-th image (image_n+1) by the n-th MLA lens for the n-th image (image_n) are generated when there is a first image (image_1) to be displayed on the display panel, relates to the following formulas:
$${S}_{1}^{′} = \frac{{f}_{1} {S}_{1}}{{S}_{1} - {f}_{1}} and {M}_{1 =} \frac{{S}^{′}}{{S}_{1}} ,$$
where the distance between the first image (image_1) and the first MLA lens is expressed as S1, the distance between the second image (image_2) and the first MLA lens is expressed as S1′, the focal distance is expressed as f1, and the magnification of the second image with respect to the first image is expressed as M1; and
$${S}_{n}^{′} = \frac{{f}_{n} {S}_{n}}{{S}_{n} - {f}_{n}} and {M}_{n =} \frac{{S}_{n}^{′}}{{S}_{n}} ,$$
where the distance between the n-th image (image_n) and the n-th MLA lens is expressed as Sₙ, the distance between the n+1-th image (image_n+1) and the n-th MLA lens is expressed as S_{n′}, the focal distance is expressed as fₙ, and the magnification of the n+1-th image with respect to the n-th image is expressed as Mₙ, and the n-th MLA lens improves the resolution compared to single lenses with magnifications of M₁, M₂, . . . Mₙ.

5. An image processing method for correcting the refractive power abnormality of a user in the display panel of claim 2, the image processing method comprising:
capturing the entire image of an underlying app;
processing the entire image of the underlying app and generating an image prime corrected according to the refractive power abnormality degree of the user; and
displaying the image prime as the entire image of the front app.

6. The image processing method for correcting the refractive power abnormality of a user in the display panel of claim 5, further comprising:
detecting whether there is a change in the underlying app; and
transparently processing the entire image of the front app when there is a change in the underlying app.

7. The image processing method for correcting the refractive power abnormality of a user in the display panel of claim 6, wherein the step of detecting whether there is a change in the underlying app comprises:
transparently processing a set of pixels at a specific location among the entire image of the front app to have a pixel value of the corresponding image of the underlying app in the set of pixels at the particular location; and
detecting a change in the underlying app by comparing a set of pixels at the transparent location between the previous image of the front app and the current image of the front app.

8. The image processing method for correcting the refractive power abnormality of a user in the display panel of claim 7, further comprising injecting a unique magic code over time for the pixel at the transparent location in at least the image prime to prevent the image prime from being unable to detect a change in the underlying app caused by the occurrence of a dropped image in which an image is missing because of the synchronization of the fence

9. The image processing method for correcting the refractive power abnormality of a user in the display panel of claim 8, wherein the step of detecting a change in the underlying app by comparing a set of pixels at the transparent location between the previous image of the front app and the current image of the front app comprises confirming the dropped image by checking the magic code of the pixel at the transparent location.

10. The image processing method for correcting the refractive power abnormality of a user in the display panel of claim 5, wherein the step of processing the entire image of the underlying app and generating an image prime corrected according to the refractive power abnormality degree of the user comprises:
detecting the angle of the user's eye based on the distance between the user's eye and the display panel and the direction between the unit lens and the user, as a step of detecting the angle of the user's eye and the angle of incidence of an image entering the eye through a unit lens of the multilayered MLA structure
locating the central position of the moved image based on the center of the lens in a state parallel to the user's eye and the angle of the eye looking at the moved image, as a step of locating the central position of an image moved by the unit lens of the multilayered MLA structure; and
extracting the image according to the size of a proportion at which the image is magnified based on the central position of the moved image.

11. An image processing method for correcting the refractive power abnormality of a user in the display panel of claim 3, the image processing method comprising:
capturing the entire image of an underlying app;
processing the entire image of the underlying app and generating an image prime corrected according to the refractive power abnormality degree of the user; and
displaying the image prime as the entire image of the front app.

12. An image processing method for correcting the refractive power abnormality of a user in the display panel of claim 4, the image processing method comprising:
capturing the entire image of an underlying app;
processing the entire image of the underlying app and generating an image prime corrected according to the refractive power abnormality degree of the user; and
displaying the image prime as the entire image of the front app.
